(19) United States
(12) Patent Application Publication
(10) Pub. No.: US 2025/0087735 A1
(43) Pub. Date: Mar. 13, 2025

(54) METAL-AIR FLOW BATTERY RECHARGING UNIT

(71) Applicant: SHARP KABUSHIKI KAISHA, Sakai City (JP)

(72) Inventors: HIROTAKA MIZUHATA, Sakai City (JP); SHINOBU TAKENAKA, Sakai City (JP)

(21) Appl. No.: 18/829,721

(22) Filed: Sep. 10, 2024

(30) Foreign Application Priority Data
Sep. 12, 2023 (JP) 2023-147254

(51) Int. Cl. H01M 8/0656; H01M 8/04186; H01M 8/04746; H01M 8/18; H01M 12/08; H01M 16/00

(52) U.S. Cl. CPC H01M 8/0656; H01M 8/04186; H01M 8/04753; H01M 8/188; H01M 12/08; H01M 16/003; H01M 2250/402

(57) ABSTRACT

A metal-air flow battery recharging unit, comprising: a first layer defining a first flow path; a positive electrode facing the first flow path; a second layer defining a second flow path; a negative electrode facing the second flow path; a separator separating the first flow path and the second flow path from each other; a positive electrode liquid flowing through the first flow path; a negative electrode liquid flowing through the second flow path; and a control unit configured to vary a flow rate of the negative electrode liquid in the second flow path.

### CROSS-REFERENCE TO RELATED APPLICATION

The present application claims priority from Japanese Application JP2023-147254, the content of which is hereby incorporated by reference into this application.

### BACKGROUND OF THE INVENTION

### 1. Field of the Invention

The present disclosure relates to a metal-air flow battery recharging unit.

U.S. Pat. No. 7,470,351 discloses a system for producing metal particles. The system applies electrolysis to solution containing dissolved metal to produce metal particles on the surface of a cathode. When formed to have a sufficient size, the metallic particles are removed from the surface of the cathode with a scraper or another suitable means. (See paragraphs 0014 and 0057.)

### SUMMARY OF THE INVENTION

As to the system disclosed in U.S. Pat. No. 7,470,351, the scraper or the other suitable means has to be moved along the surface of the cathode to remove the metal particles from the surface of the cathode. Hence, the system causes problems such as consumption of power required to move the scraper or the other suitable means, and decrease in durability because of the motion of the scraper or the other suitable means along the surface of the cathode.

One aspect of the present disclosure is devised in view of the above problems. One aspect of the present disclosure sets out to provide a metal-air flow battery recharging unit that can, for example, remove negative-electrode active material particles from a negative electrode without consuming a large amount of power. Furthermore, the metal-air flow battery recharging unit achieves high durability because the metal-air flow battery charger eliminates the needs for physical contact with, for example, a scraper.

A metal-air flow battery recharging unit according to a first aspect of the present disclosure includes: a first layer defining a first flow path; a positive electrode facing the first flow path; a second layer defining a second flow path; a negative electrode facing the second flow path; a separator separating the first flow path and the second flow path from each other; a positive electrode liquid flowing through the first flow path; a negative electrode liquid flowing through the second flow path; and a control unit that varies a flow rate of the negative electrode liquid in the second flow path.

A metal-air flow battery recharging unit according to a second aspect of the present disclosure includes: a first layer defining a first flow path; a positive electrode facing the first flow path; a second layer defining a second flow path; a negative electrode facing the second flow path; a separator separating the first flow path and the second flow path from each other; a positive electrode liquid flowing through the first flow path; a negative electrode liquid flowing through the second flow path; and an energization control unit that varies a current value of a current flowing between the positive electrode and the negative electrode.

### BRIEF DESCRIPTION OF DRAWINGS

FIG. 1 is a view schematically illustrating a metal-air flow battery of a first embodiment;

FIG. 2 is an exploded perspective view schematically illustrating a rechargeable cell included in the metal-air flow battery of the first embodiment;

FIG. 3 is a cross-sectional view schematically illustrating the rechargeable cell included in the metal-air flow battery of the first embodiment;

FIG. 4A is a graph showing a first control example of a current value of a current flowing between a positive electrode and a negative electrode of the rechargeable cell included in the metal-air flow battery of the first embodiment;

FIG. 4B is a graph showing a first control example of a flow rate of a negative electrode liquid in a second flow path of the rechargeable cell included in the metal-air flow battery of the first embodiment;

FIG. 5A is a graph showing a second control example of a current value of a current flowing between the positive electrode and the negative electrode of the rechargeable cell included in the metal-air flow battery of the first embodiment;

FIG. 5B is a graph showing a second control example of a flow rate of a negative electrode liquid in the second flow path of the rechargeable cell included in the metal-air flow battery of the first embodiment;

FIG. 6A is a graph showing a third control example of a current value of a current flowing between the positive electrode and the negative electrode of the rechargeable cell included in the metal-air flow battery of the first embodiment;

FIG. 6B is a graph showing a third control example of a flow rate of a negative electrode liquid in the second flow path of the rechargeable cell included in the metal-air flow battery of the first embodiment;

FIG. 7 is a graph showing a fourth control example of a current value of a current flowing between the positive electrode and the negative electrode of the rechargeable cell included in the metal-air flow battery of the first embodiment;

FIG. 8 is a graph showing a fifth control example of a flow rate of a negative electrode liquid in the second flow path of the rechargeable cell included in the metal-air flow battery of the first embodiment;

FIG. 9 is a cross-sectional view schematically illustrating the rechargeable cell included in the metal-air flow battery according to a first modification of the first embodiment;

FIG. 10 is a cross-sectional view schematically illustrating the rechargeable cell included in the metal-air flow battery according to a second modification of the first embodiment;

FIG. 11 is a cross-sectional view schematically illustrating the rechargeable cell included in the metal-air flow battery according to a third modification of the first embodiment;

FIG. 12 is a cross-sectional view schematically illustrating the rechargeable cell included in the metal-air flow battery according to a fourth modification of the first embodiment; and

FIG. 13 is a cross-sectional view schematically illustrating a rechargeable cell stack that can be used instead of the rechargeable cell included in the metal-air flow battery of the first embodiment.

### DETAILED DESCRIPTION OF THE INVENTION

Embodiments of the present disclosure will be described below with reference to the drawings. Note that, throughout the drawings, like reference signs denote identical or similar constituent features. Such features will not be repeatedly elaborated upon.

### 1. First Embodiment

### 1.1 Metal-Air Flow Battery

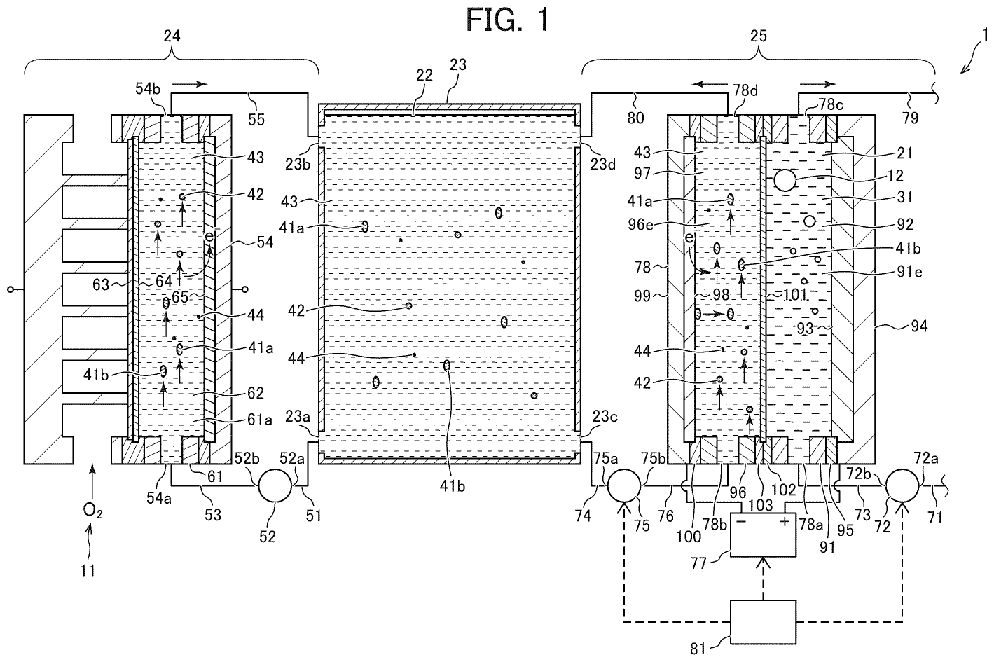

FIG. 1 is a view schematically illustrating a metal-air flow battery of a first embodiment.

When discharging electricity, a metal-air flow battery 1 of the first embodiment illustrated in FIG. 1 absorbs an oxygen gas 11 from the air around the metal-air flow battery 1. When charged with electricity, the metal-air flow battery 1 releases an oxygen gas 12 to the air around the metal-air flow battery 1.

The metal-air flow battery 1 is a zinc-air flow battery. Hence, a negative-electrode active material of the metal-air flow battery 1 is of a zinc-containing species. Note that, the metal-air flow battery 1 may be a metal-air flow battery other than the zinc-air flow battery. Hence, the negative-electrode active material of the metal-air flow battery 1 may be of a metal-containing species other than the zinc-containing species. Examples of the metal-containing species other than the zinc-containing species include a cadmium-containing species, a lithium-containing species, a sodium-containing species, a magnesium-containing species, a lead-containing species, a tin-containing species, an aluminum-containing species, and an iron-containing species. A metal included in the metal-containing species may be either formed only of a metal serving as a main component, or formed of a metal serving as a main component and an alloy serving as an accessory component. The metal-containing species can be either a metal or an oxide. Whether the metal-containing species contains either a metal or an oxide is determined depending on to what degree either the discharge reaction or the recharge reaction progresses.

As illustrated in FIG. 1, the metal-air flow battery 1 includes: a positive electrode liquid 21; a negative electrode liquid 22; a storage unit 23; a discharging unit 24; and a recharging unit 25.

### 1.2 Positive Electrode Liquid

As illustrated in FIG. 1, the positive electrode liquid 21 contains a first electrolyte solution 31.

The first electrolyte solution 31 is a potassium hydroxide aqueous solution. The first electrolyte solution 31 may be either an aqueous solution other than a potassium hydrate aqueous solution, or an electrolyte solution other than an aqueous solution.

Water contained in the first electrolyte solution 31 is a reactant of the recharge reaction caused by the recharging unit 25.

### 1.3 Negative Electrode Liquid

As illustrated in FIG. 1, the negative electrode liquid 22 contains: reduced negative-electrode active material particles 41a; oxidized negative-electrode active material particles 41b; negative-electrode active material ions 42; and a second electrolyte solution 43.

As described above, the metal-air flow battery 1 is a zinc-air flow battery. Hence, the reduced negative-electrode active material particles 41a, the oxidized negative-electrode active material particles 41b, and the negative-electrode active material ions 42 are of zinc-containing species. The reduced negative-electrode active material particles 41a are metallic zinc (Zn) particles, and the oxidized negative-electrode active material particles 41b are zinc oxide (ZnO) particles. The reduced negative-electrode active material particles 41a and the oxidized negative-electrode active material particles 41b are dispersed in the second electrolyte solution 43. Hence, the negative electrode liquid 22 is in a slurry state. The reduced negative-electrode active material particles 41a have a particle size of, for example, several micrometers. The oxidized negative-electrode active material particles 41b have a particle size of, for example, several tens to several hundreds namometers. The negative-electrode active material ions 42, which are zincate ions (Zn(OH)₄²⁻), are dissolved in the second electrolyte solution 43.

The second electrolyte solution 43 is a potassium hydroxide aqueous solution. The second electrolyte solution 43 may be either an aqueous solution other than a potassium hydrate aqueous solution, or an electrolyte solution other than an aqueous solution.

The negative-electrode active material ions 42 are a reactant of the recharge reaction caused by the recharging unit 25. The reduced negative-electrode active material particles 41a are a product of the recharge reaction caused by the recharging unit 25.

### 1.4 Storage Unit

The storage unit 23 stores the negative electrode liquid 22. The storage unit 23 includes: an outlet 23a; an inlet 23b; an outlet 23c; and an inlet 23d. The outlet 23a and the outlet 23c let the negative electrode liquid 22 flow away. The inlet 23b and the inlet 23d let the negative electrode liquid 22 flow in.

### 1.5 Discharging Unit

The discharging unit 24 absorbs the oxygen gas 11 from the air around the discharging unit 24. The discharging unit 24 receives the negative electrode liquid 22 from the storage unit 23. The discharging unit 24 causes the absorbed oxygen gas 11 and the influent negative electrode liquid 22 to be involved in a discharge reaction for generating discharge power, and causes the negative electrode liquid 22, which has been involved in the discharge reaction, to flow out to the storage unit 23. The discharging unit 24 causes the oxygen gas 11 and the reduced negative-electrode active material particles 41a contained in the negative electrode liquid 22 to be involved in the discharge reaction so that the reduced negative-electrode active material particles 41a are eliminated. Thus, the discharging unit generates the negative-electrode active material ions 42.

As illustrated in FIG. 1, the discharging unit 24 includes: a pipe 51; a pump 52; a pipe 53; a discharging cell 54; and a pipe 55.

The pipe 51 guides the negative electrode liquid 22 from the outlet 23a of the storage unit 23 to the inlet 52a of the pump 52. Hence, the pipe 51 lets the negative electrode liquid 22, which has flowed out from the outlet 23a, flow into the inlet 52a.

The pump 52 causes the negative electrode liquid 22, which has flowed into an inlet 52a of the pump 52, to flow out from an outlet 52b of the pump 52. Here, the pump 52 creates a flow of the negative electrode liquid 22. Hence, the pump 52 sends the negative electrode liquid 22 from the storage unit 23 to the discharging cell 54.

The pipe 53 guides the negative electrode liquid 22 from the outlet 52b of the pump 52 to an inlet 54a of the discharging cell 54. Hence, the pipe 53 lets the negative electrode liquid 22, which has flowed out from the outlet 52b, flow into the inlet 52a.

The discharging cell 54 absorbs the oxygen gas 11 from the air around the discharging cell 54. The discharging cell 54 makes the negative electrode liquid 22, which has flowed into the inlet 54a of the discharging cell 54, flow out from an outlet 54b of the discharging cell 54. Here, the discharging cell 54 causes the absorbed oxygen gas 11 and the influent negative electrode liquid 22 to be involved in a discharge reaction, and causes the negative electrode liquid 22, which has been involved in the discharge reaction, to flow out from the outlet 54b. The discharging cell 54 outputs discharge power generated by the discharge reaction.

The pipe 55 guides the negative electrode liquid 22 from the outlet 54b of the discharging cell 54 to the inlet 23b of the storage unit 23. Hence, the pipe 55 lets the negative electrode liquid 22, which has flowed out from the outlet 54b, flow into the inlet 23b.

### 1.6 Discharging Cell

As illustrated in FIG. 1, the discharging cell 54 includes: a layer 61; a negative electrode liquid 62; a positive electrode 63; a separator 64; and a negative electrode 65.

The layer 61 defines a flow path 61a. The flow path 61a is defined from the inlet 54a to the outlet 54b of the discharging cell 54. Hence, the flow path 61a transmits the negative electrode liquid 22, which has flowed into the inlet 54a, and lets the transmitted negative electrode liquid 22 flow out from the outlet 54b.

The negative electrode liquid 62 flows through the flow path 61a of the layer 61. The negative electrode liquid 62 is a portion of the negative electrode liquid 22 contained in the metal-air flow battery 1.

The positive electrode 63 is in contact with the air around the discharging cell 54. Hence, the positive electrode 63 is supplied with the oxygen gas 11 contained in the air around the discharging cell 54. As a result, the positive electrode 63 causes a reduction reaction of oxygen represented by Formula (1).

O₂+2H₂O+4e⁻→4OH (1)

The positive electrode 63 faces the flow path 61a of the layer 61 through the separator 64. Hence, the positive electrode 63 transfers OH⁻, which is a product of the reduction reaction of the oxygen represented by Formula (1), from and to the negative electrode liquid 62 flowing in the flow path 61a through the separator 64.

The negative electrode 65 faces the flow path 61a of the layer 61. Hence, the negative electrode 65 is in contact with the negative electrode liquid 62 flowing in the flow path 61a. As a result, the negative electrode 65 causes an oxidation reaction of metallic zinc represented by Formulae (2) and (3).

Zn+4OH⁻→Zn(OH)₄²⁻+2e⁻ (2)

Zn(OH)₄²⁻→ZnO+H₂O+2OH⁻ (3)

Because of the reduction reaction of the oxygen with the positive electrode 63 and the oxidation reaction of the metallic zinc with the negative electrode 65, the discharging cell 54 causes an overall reaction represented by Formula (4).

2Zn+O₂→2ZnO (4)

As a result, the discharging cell 54 discharges electricity when the metallic zinc transforms to zinc oxide.

### 1.7 Recharging Unit

The recharging unit 25 receives the negative electrode liquid 22 from the storage unit 23. The recharging unit 25 causes the influent negative electrode liquid 22 to be involved in a recharge reaction so that the negative electrode liquid 22 is recycled, and causes the negative electrode liquid 22, which has been involved in the recharge reaction, to flow out to the storage unit 23. The recharging unit 25 causes the negative-electrode active material ions 42 contained in the negative electrode liquid 22 to be involved in the recharge reaction so that the negative-electrode active material ions 42 are eliminated, and generates the reduced negative-electrode active material particles 41a.

As illustrated in FIG. 1, the recharging unit 25 includes: a pipe 71; a pump 72; a pipe 73; a pipe 74; a pump 75; a pipe 76; a power supply 77; a rechargeable cell 78; a pipe 79; a pipe 80; and a control circuit 81.

The pipe 71 guides the positive electrode liquid 21 from a not-shown supply source of the positive electrode liquid 21 to an inlet 72a of the pump 72. Hence, the pipe 71 lets the positive electrode liquid 21, which has flowed out from the supply source of the positive electrode liquid 21, flow into the inlet 72a.

The pump 72 causes the positive electrode liquid 21, which has flowed into the inlet 72a of the pump 72, to flow out from an outlet 72b of the pump 72. Here, the pump 72 creates a flow of the positive electrode liquid 21. Hence, the pump 72 sends the positive electrode liquid 21 from the supply source of the positive electrode liquid 21 to the rechargeable cell 78.

The pipe 73 guides the positive electrode liquid 21 from the outlet 72b of the pump 72 to an inlet 78a of the rechargeable cell 78. Hence, the pipe 73 lets the positive electrode liquid 21, which has flowed out from the outlet 72b, flow into the inlet 78b.

The pipe 74 guides the negative electrode liquid 22 from the outlet 23c of the storage unit 23 to an inlet 75a of the pump 75. Hence, the pipe 74 lets the negative electrode liquid 22, which has flowed out from the outlet 23c, flow into the inlet 75a.

The pump 75 causes the negative electrode liquid 22, which has flowed into the inlet 75a of the pump 75, to flow out from an outlet 75b of the pump 75. Here, the pump 75 creates a flow of the negative electrode liquid 22. Hence, the pump 75 sends the negative electrode liquid 22 from the storage unit 23 to the rechargeable cell 78.

The pipe 76 guides the negative electrode liquid 22 from the outlet 75b of the pump 75 to an inlet 78b of the rechargeable cell 78. Hence, the pipe 76 lets the negative electrode liquid 22, which has flowed out from the outlet 75b, flow into the inlet 78b.

The power supply 77 inputs charging power to the rechargeable cell 78.

The rechargeable cell 78 makes: the positive electrode liquid 21, which has flowed into the inlet 78a of the rechargeable cell 78, flow out from an outlet 78c of the rechargeable cell 78; and the negative electrode liquid 22, which has flowed into the inlet 78b of the rechargeable cell 78, flow out from the outlet 78d of the rechargeable cell 78. Here, the rechargeable cell 78 causes: the influent positive electrode liquid 21 and negative electrode liquid 22 to be involved in a recharge reaction caused by the charging power; the positive electrode liquid 21, which has been involved in the recharge reaction, to flow out from the outlet 78c; and the negative electrode liquid 22, which has been involved in the recharge reaction, to flow out from the outlet 78d. Then, the rechargeable cell 78 releases the oxygen gas 12, which has been generated by the recharge reaction, to the air around the rechargeable cell 78.

The pipe 79 guides the positive electrode liquid 21 from the outlet 78c of the rechargeable cell 78 to the supply source of the positive electrode liquid 21. Hence, the pipe 79 lets the positive electrode liquid 21, which has flowed out from the outlet 78c, flow into the supply source of the positive electrode liquid 21.

The pipe 80 guides the negative electrode liquid 22 from the outlet 78d of the rechargeable cell 78 to the inlet 23d of the storage unit 23. Hence, the pipe 80 lets the negative electrode liquid 22, which has flowed out from the outlet 78d, flow into the inlet 23d.

The pipe 71, the pump 72, the pipe 73, and the pipe 79 constitute a mechanism to create a flow of the positive electrode liquid 21; that is, to let the positive electrode liquid 21 flow into the inlet 78a of the rechargeable cell 78 and flow out from the outlet 78c of the rechargeable cell 78.

The pipe 74, the pump 75, the pipe 76, and the pipe 80 constitute a mechanism to create a flow of the negative electrode liquid 22; that is, to let the negative electrode liquid 22 flow into the inlet 78b of the rechargeable cell 78 and flow out from the outlet 78d of the rechargeable cell 78.

The control circuit 81 controls the pump 72 and the pump 75. Hence, the control circuit 81 constitutes a control unit that varies the flow rate of the positive electrode liquid 92 in the first flow path 91e of the rechargeable cell 78, and/or the flow rate of the negative electrode liquid 97 in the second flow path 96e of the rechargeable cell 78.

The control circuit 81 controls the power supply 77. Hence, the control circuit 81 constitutes an energization control unit that varies the current value of a current flowing between the positive electrode 93 and the negative electrode 98 of the rechargeable cell 78.

The control circuit 81 includes: a microcontroller; and a peripheral circuit. The microcontroller includes: a processor; and a memory. The processor executes a program stored in the memory to cause the microcontroller and the peripheral circuit to operate as the control unit and the energization control unit described above. Some or all of the processing executed by the microcontroller may be executed by a dedicated electronic circuit.

### 1.8 Rechargeable Cell

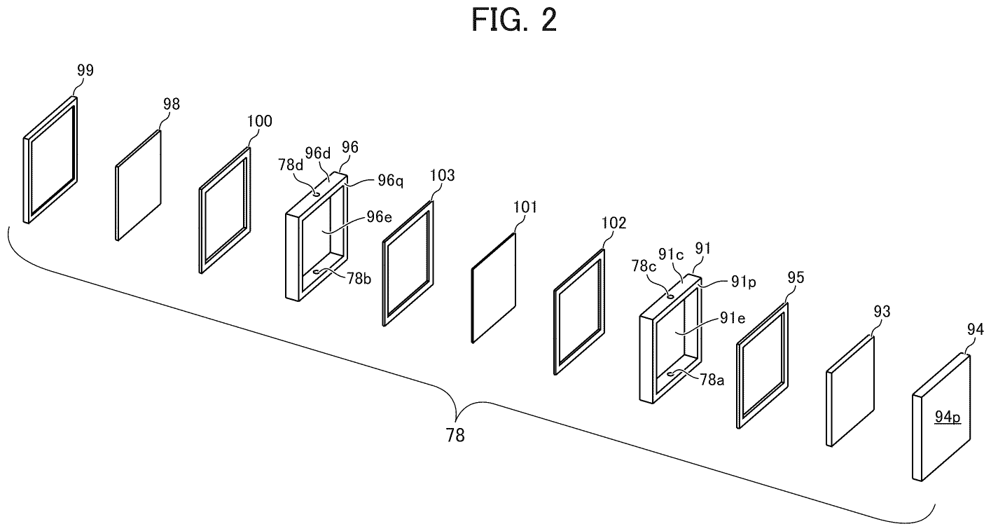

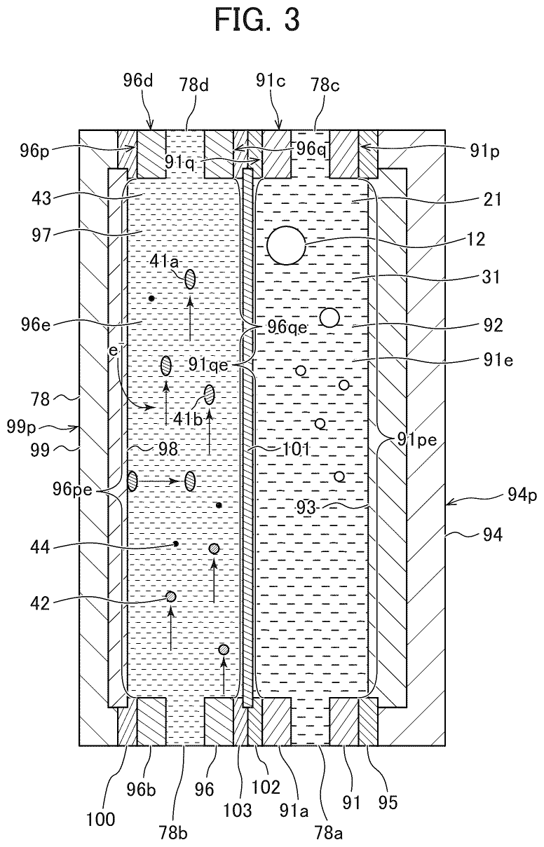

FIG. 2 is an exploded perspective view schematically illustrating a rechargeable cell included in the metal-air flow battery of the first embodiment. FIG. 3 is a cross-sectional view schematically illustrating the rechargeable cell included in the metal-air flow battery of the first embodiment.

As illustrated in FIGS. 2 and 3, the rechargeable cell 78 includes: a first layer 91; the positive electrode liquid 92; the positive electrode 93; a conductive plate 94; a gasket 95; a second layer 96; the negative electrode liquid 97; the negative electrode 98; a conductive plate 99; a gasket 100; a separator 101; a gasket 102; and a gasket 103.

The first layer 91 is shaped into a rectangular frame. Hence, the first layer 91 has: an opening surface 91p; an opening surface 91q; an end surface 91a; and an end surface 91c. The opening surface 91p and the opening surface 91q are across from each other. The end surface 91a and the end surface 91c are across from each other. The first layer 91 may be shaped into a frame other than the rectangular frame.

The first layer 91 defines a first flow path 91a.

The first flow path 91e of the first layer 91 is exposed to the opening surface 91p and the opening surface 91q. The opening surface 91p and the opening surface 91q respectively have an opening 91pe and an opening 91qe.

The first flow path 91e is exposed to the end surface 91a and the end surface 91c. The end surface 91a and the end surface 91c respectively have the inlet 78a and the outlet 78c. Hence, the first flow path 91e is defined from the inlet 78a to the outlet 78c. Thus, the flow path 91e transmits the positive electrode liquid 92, which has flowed into the inlet 78a, and lets the transmitted positive electrode liquid 21 flow out from the outlet 78c.

The inlet 78a and the outlet 78c of the rechargeable cell 78 are disposed respectively toward a vertically lower position and toward a vertically upper position. Hence, the first flow path 91e of the first layer 91 includes a portion to guide the positive electrode liquid 92 in the vertical direction. The inlet 78a may be disposed in a position other than the vertically lower position. The outlet 78c may be disposed in a position other than the vertically upper position.

The positive electrode liquid 92 flows in the first flow path 91e of the first layer 91. The positive electrode liquid 92 is a portion of the positive electrode liquid 21. As described above, the inlet 78a and the outlet 78c of the rechargeable cell 78 are disposed respectively toward the vertically lower position and toward the vertically upper position. Hence, in the portion to guide the positive electrode liquid 92 in the vertical direction, the positive electrode liquid 92 flows in a direction from the vertically lower position toward the vertically upper position.

If the positive electrode liquid 92 flows in the direction from the vertically upper position toward the vertically lower position, the positive electrode liquid 92 flows down from the first flow path 91e of the first layer 91 even before the first flow path 91e is completely filled with the positive electrode liquid 92. Hence, the first flow path 91e could not be completely filled with the positive electrode liquid 92. Whereas, if the positive electrode liquid 92 flows in the direction from the vertically lower position toward the vertically upper position, the first flow path 91e is completely filled with the positive electrode liquid 92. After that, the first flow path 91e overflows with the positive electrode liquid 92. Hence, the first flow path 91e can be completely filled with the positive electrode liquid 92.

The oxygen gas 12 generated with the positive electrode 93 moves from the vertically lower position to the vertically upper position not only by buoyancy but also in the flow of the positive electrode liquid 92. Such a feature can encourage the oxygen gas 12 to discharge from the rechargeable cell 78.

The positive electrode 93 is shaped into a rectangular plate. The positive electrode 93 is disposed to the opening surface 91p of the first layer 91. Hence, the positive electrode 93 closes the opening 91pe of the first layer 91, and faces the first flow path 91e of the first layer 91. Thus, the positive electrode 93 is in contact with the positive electrode liquid 92 flowing in the first flow path 91e. As a result, the positive electrode 93 causes an oxidation reaction of water represented by Formula (5).

4OH⁻→O₂+2H₂+4e⁻ (5)

Hence, the rechargeable cell 78 generates the oxygen gas 12 by the oxidation reaction of water with the positive electrode 93. The generated oxygen gas 12 is discharged from the rechargeable cell 78.

The positive electrode 93 is made of a material highly capable of generating oxygen. Such a feature can enhance efficiency in recharging the rechargeable cell 78. Furthermore, the feature can stabilize an operation of recharging the rechargeable cell 78. Examples of the material highly capable of generating oxygen include nickel.

The conductive plate 94 is shaped into a rectangular plate. The conductive plate 94 is disposed to the opening surface 91p of the first layer 91, and overlaps the positive electrode 93. Thus, the conductive plate 94 is in contact with the positive electrode 93, and defines a conductive path to the positive electrode 93.

The gasket 95 is sandwiched, and liquid-tightly seals a gap, between: the opening surface 91p of the first layer 91; and the positive electrode 93 and the conductive plate 94.

The second layer 96 is shaped into a rectangular frame. Hence, the second layer 96 has: an opening surface 96p; an opening surface 96q; an end surface 96b; and an end surface 96d. The opening surface 96p and the opening surface 96q are across from each other. The end surface 96b and the end surface 96d are across from each other.

The second layer 96 defines the second flow path 96e.

The second flow path 96e of the second layer 96 is exposed to the opening surface 96p and the opening surface 96q. The opening surface 96p and the opening surface 96q respectively have an opening 96pe and an opening 96qe.

The second flow path 96e is exposed to the end surface 96b and the end surface 96d. The end surface 96b and the end surface 96d respectively have the inlet 78b and the outlet 78d. Hence, the second flow path 96e is defined from the inlet 78b to the outlet 78d. Thus, the second flow path 96e transmits the negative electrode liquid 97, which has flowed into the inlet 78b, and lets the transmitted negative electrode liquid 97 flow out from the outlet 78d.

The inlet 78b and the outlet 78d of the rechargeable cell 78 are disposed respectively toward a vertically lower position and toward a vertically upper position. Hence, the second flow path 96e of the second layer 96 includes a portion to guide the negative electrode liquid 97 in the vertical direction.

The negative electrode liquid 97 flows in the second flow path 96e of the second layer 96. The negative electrode liquid 97 is a portion of the negative electrode liquid 22. As described above, the inlet 78b and the outlet 78d of the rechargeable cell 78 are disposed respectively toward the vertically lower position and toward the vertically upper position. Hence, in the portion to guide the negative electrode liquid 97 in the vertical direction, the negative electrode liquid 97 flows in a direction from the vertically lower position toward the vertically upper position.

If the negative electrode liquid 97 flows in the direction from the vertically upper position toward the vertically lower position, the negative electrode liquid 97 flows down from the second flow path 96e of the second layer 96 even before the second flow path 96e is completely filled with the negative electrode liquid 97. Hence, the second flow path 96e could not be completely filled with the negative electrode liquid 97. Whereas, if the negative electrode liquid 97 flows in the direction from the vertically lower position toward the vertically upper position, the second flow path 96e is completely filled with the negative electrode liquid 97. After that, the second flow path 96e overflows with the negative electrode liquid 97. Hence, the second flow path 96e can be completely filled with the negative electrode liquid 97.

The reduced negative-electrode active material particles 41a generated with the negative electrode 98 are greater in specific gravity than the negative electrode liquid 97. Hence, if the negative electrode liquid 97 flows in the direction from the vertically upper position toward the vertically lower position, the reduced negative-electrode active material particles 41a move from the vertically upper position to the vertically lower position, and settle out. However, if the negative electrode liquid 97 flows in the direction from the vertically lower position toward the vertically upper position, the reduced negative-electrode active material particles 41a move from the vertically lower position toward the vertically upper position against gravity in the flow of the positive electrode liquid 92. Thus, the reduced negative-electrode active material particles 41a grow in particle size to sufficiently receive drag of the negative electrode liquid 97. After that, the reduced negative-electrode active material particles 41a can be discharged from the rechargeable cell 78.

The negative electrode 98 is shaped into a rectangular plate. The negative electrode liquid 98 is disposed to the opening surface 96p of the second layer 96. Hence, the negative electrode 98 closes the opening 96pe of the second layer 96, and faces the second flow path 96e of the second layer 96. Thus, the negative electrode 98 is in contact with the negative electrode liquid 97 flowing in the second flow path 96e. Accordingly, the negative electrode 98 is supplied with the negative electrode liquid containing zincate ions Zn(OH)₄²⁻ and/or zinc oxide ZnO generated by the oxidation reaction of metallic zinc represented by Formulae (2) and (3). As a result, the negative electrode 98 causes a reduction reaction to metallic zinc represented by Formulae (6) and (7).

ZnO+H₂O+2OH⁻→Zn(OH)₄ (6)

Zn(OH)₄²⁻+2e⁻→Zn+4OH⁻ (7)

Hence, the rechargeable cell 78 generates the reduced negative-electrode active material particles 41a by the reduction reaction to metallic zinc with the negative electrode 98. When generated, the reduced negative-electrode active material particles 41a accrete on the negative electrode 98.

The negative electrode 98 is made of a material capable of reducing a hydrogen-generating reaction conflicting with the reduction reaction to metallic zinc. The material capable of reducing the hydrogen-generating reaction includes at least one selected from the group consisting of, for example, carbon, copper, and magnesium. Carbon includes, for example, graphite. Carbon is resistant to corrosion. Hence, if the negative electrode 98 is made of carbon, the carbon can reduce a decrease in efficiency in recharging the rechargeable cell 78 because of corrosion of the negative electrode 98. Such a feature can enhance long-term stability of the rechargeable cell 78. Furthermore, the reduced negative-electrode active material particles 41a is low in adhesion to magnesium. Hence, if the negative electrode 98 is made of magnesium, the magnesium can remove the reduced negative-electrode active material particles 41a from the negative electrode 98, thereby successfully discharging the reduced negative-electrode active material particles 41a out of the rechargeable cell 78.

The conductive plate 99 is shaped into a rectangular plate. The conductive plate 99 is disposed to the opening surface 96p of the second layer 96, and overlaps the negative electrode 98. Thus, the conductive plate 99 is in contact with the negative electrode 98, and defines a conductive path to the negative electrode 98.

The gasket 100 is sandwiched, and liquid-tightly seals a gap, between: the opening surface 96p of the second layer 96; and the negative electrode 98 and the conductive plate 99.

The separator 101 is shaped into a sheet. The separator 101 is flexible. The separator 101 is disposed to the opening surface 91q of the first layer 91. Hence, the separator 101 closes the opening 91qe of the first layer 91, and faces the first flow path 91e of the first layer 91. Furthermore, the separator 101 is disposed to the opening surface 96q of the second layer 96. Hence, the separator 101 closes the opening 96qe of the second layer 96, and faces the second flow path 96e of the second layer 96.

The separator 101 is sandwiched between the first layer 91 and the second layer 96. Hence, the separator 101 separates the first flow path 91e of the first layer 91 and the second flow path 96e of the second layer 96 from each other. The separator 101 does not transmit the reduced negative-electrode active material particles 41a, the oxidized negative-electrode active material particles 41b, or a thickener 44. Hence, the separator 101 keeps the reduced negative-electrode active material particles 41a, the oxidized negative-electrode active material particles 41b, and the thickener 44 from moving from the negative electrode liquid 97 to the positive electrode 92.

The separator 101 is high in ionic conduction. Thus, the separator 101 transmits hydroxide ions OH⁻. Hence, the separator 101 can transmit the hydroxide ions OH⁻ from the negative electrode liquid 97 to the positive electrode liquid 92.

The separator 101 has to keep the reduced negative-electrode active material particles 41a, the oxidized negative-electrode active material particles 41b, and the thickener 44 from transmitting. That is why the separator 101 is a film not having pores of desirably 50 nm or more, and more desirably 100 nm or more. The separator 101 is, for example, an anion exchange film, a hydrogel film, or a film including a plurality of inorganic ion conductor particles and a resin impregnated in grain boundaries between the plurality of inorganic ion conductor particles.

In the reduction reaction to metallic zinc with the negative electrode 98, that is, in the electrodeposition reaction of metallic zinc with the negative electrode 98, nonuniform distribution of the current might allow dendritic metallic zinc to grow from the negative electrode 98. The separator 101 is highly resistant to dendrites. Hence, the separator 101 keeps the dendritic metallic zinc from growing beyond the separator 101. Such a feature can prevent the positive electrode 93 and the negative electrode 98 from being short-circuited to each other through dendritic metallic zinc.

The gasket 102 is sandwiched, and liquid-tightly seals a gap, between the opening surface 91q of the first layer 91 and the separator 101.

The gasket 103 is sandwiched, and liquid-tightly seals a gap, between the opening surface 96q of the second layer 96 and the separator 101.

### 1.9 Theoretical Voltage of Metal-Air Flow Battery

Because of the oxidation reaction of water with the positive electrode 93 and the reduction reaction to metallic zinc with the negative electrode 98, the rechargeable cell 78 causes an overall reaction represented by Formula (8).

2Zn+O₂→2ZnO (8)

Hence, when recharged with electricity, the rechargeable cell 78 transforms zinc oxide into metallic zinc.

During the discharge reaction and the recharge reaction, the positive electrode and the negative electrode respectively have potentials of −1.25 V and 0.40 V in the standard hydrogen electrode reference. Hence, the metal-air flow battery 1 has a theoretical voltage of 1.65 V.

### 1.10 Viscosities of Positive Electrode Liquid and Negative Electrode Liquid

The positive electrode liquid 92 has a first viscosity. The negative electrode liquid 97 has a second viscosity higher than the first viscosity. The first viscosity is, for example, 1 mPa·s or more and 9 mPa·s or less, and desirably, 2 mPa·s or more and 3 mPa·s or less. The second viscosity is, for example, 100 mPa·s or higher and 2000 mPa·s or lower, and desirably, 200 mPa·s or higher and 500 mPa·s or lower. The viscosity of the positive electrode liquid 92 can be measured with, for example, an Ubbelohde viscometer. The viscosity of the negative electrode liquid 97 can be measured with, for example, VT-06 manufactured by Rion Co., Ltd.

If the positive electrode liquid 92 has a high viscosity, the oxygen gas 12 generated with the positive electrode 93 is likely to be taken into the positive electrode liquid 92, and the positive electrode liquid 92 becomes foamy. This state makes it difficult to separate the oxygen gas 12 from the positive electrode liquid 92, and to discharge the separated oxygen gas 12 from the rechargeable cell 78. Such a problem decreases efficiency in recharging the rechargeable cell 78.

Whereas, if the positive electrode liquid 92 has a low viscosity, a turbulent flow of the positive electrode liquid 92 promotes growth of bubbles of the oxygen gas 12. This state makes it easy to separate the oxygen gas 12 from the positive electrode liquid 92 and to discharge the separated oxygen gas 12 from the rechargeable cell 78. Such a feature increases efficiency in recharging the rechargeable cell 78.

If the negative electrode liquid 97 has a low viscosity, the drag on the reduced negative-electrode active material particles 41a decreases when the negative electrode liquid 97 acts on the reduced negative-electrode active material particles 41a. This state makes it difficult to remove the reduced negative-electrode active material particles 41a from the negative electrode 98 and to discharge the reduced negative-electrode active material particles 41a, which has been removed, from the rechargeable cell 78. Furthermore, the state makes it difficult to prevent the reduced negative-electrode active material particles 41a from settling out by gravity.

Whereas, if the negative electrode liquid 97 has a high viscosity, the drag on the reduced negative-electrode active material particles 41a increases when the negative electrode liquid 97 acts on the reduced negative-electrode active material particles 41a. This state makes it easy to remove the reduced negative-electrode active material particles 41a from the negative electrode 98, and to discharge the reduced negative-electrode active material particles 41a, which has been removed, from the rechargeable cell 78. Furthermore, the feature makes it easy to prevent the reduced negative-electrode active material particles 41a from settling out by gravity.

As can be seen, the second viscosity is set higher than the first viscosity to encourage removal of the reduced negative-electrode active material particles 41a from the negative electrode 98. In such a case, a moving unit is not required for separating the reduced negative-electrode active material particles 41a from the negative electrode 98. Thanks to the feature, the metal-air flow battery 1 can remove the reduced negative-electrode active material particles 41a from the negative electrode 98 without consuming a large amount of power, and achieve high durability.

The viscosity of the negative electrode liquid 97 is adjusted with the kind and/or concentration of the thickener 44 contained in the negative electrode liquid 97. Examples of the thickener 44 include an organic polymer material and inorganic particles having a particle size of less than 1 μm. Examples of the organic polymer material include polyacrylic acid, carboxymethyl cellulose, sodium alginate, and acrylic acid-alkyl methacrylate copolymer. Examples of the inorganic substance include calcium hydroxide and potassium silicate. The viscosity of the negative electrode liquid 97 may be adjusted with the concentration of the oxidized negative-electrode active material particles 41b having a particle size of less than 1 μm. If the viscosity of the negative electrode liquid 97 is adjusted with the concentration of the oxidized negative-electrode active material particles 41b, the negative electrode liquid 97 does not have to contain the thickener 44. If either calcium hydroxide or potassium silicate is used as the thickener 44 when the negative-electrode active material ions 42 are zincate ions (Zn(OH)₄²⁻), the calcium hydroxide or the potassium silicate affects solubility of the zincate ions (Zn(OH)₄²⁻). Such a feature can set the concentration of the negative-electrode active material ions 42 in the negative electrode liquid 97 to a concentration suitable for the recharge reaction.

If the negative electrode liquid 97 contains the thickener 44, the separator 101 does not transmit the thickener 44. Thanks to such a feature, the separator 101 keeps the thickener 44 from moving from the negative electrode liquid 97 to the positive electrode liquid 92. The feature makes it possible to maintain the viscosity of the negative electrode liquid 97 higher than the viscosity of the positive electrode liquid 92 for a long time. Thanks to the feature, the oxygen gas 12 is separated from the positive electrode liquid 92, and the separated oxygen gas 12 is discharged from the rechargeable cell 78, more readily than ever before. Hence, the feature can maintain, for a long time, a state in which the reduced negative-electrode active material particles 41a are removed from the negative electrode 98 and the reduced negative-electrode active material particles 41a, which has been removed, are readily discharged from the rechargeable cell 78. As a result, the feature makes it possible to maintain high the efficiency in recharging the rechargeable cell 78 for a long time.

### 1.11 Additional Components of Negative Electrode Liquid

The negative electrode liquid 97 desirably contains at least one kind of ions selected from the group consisting of Group 13 metal elements, Group 14 metal elements, and Group 15 metal elements, more desirably, at least one kind of ions selected from the group consisting of indium and thallium contained in Group 13 metal elements, tin and lead contained in Group 14 metal elements, and antimony and bismuth contained in Group 15 metal elements, and particularly desirably, indium ions. If the negative electrode liquid 22 contains these ions, the reduced negative-electrode active material particles 41a can be less likely to adhere to the negative electrode 98. Such a feature further makes it easy to remove the reduced negative-electrode active material particles 41a from the negative electrode 98 and to discharge the reduced negative-electrode active material particles 41a, which has been removed, from the rechargeable cell 78. If the negative electrode liquid 97 contains ions of these metals, the ions are contained at a concentration of preferably 20 to 300 ppm, and more preferably, 50 to 200 ppm. If the concentration of ions of these metals is less than 20 ppm, the adhesion of the reduced negative-electrode active material particles 41a to the negative electrode 98 might not be sufficiently reduced. If the ion concentration of these metals exceeds 300 ppm, these metals cannot be dissolved as ions, and might be deposited in the solution. In particular, the reason why the adhesion of the reduced negative-electrode active material particles 41a to the negative electrode 98 is low when the negative electrode liquid 22 contains indium ions would be because the ionization tendency of indium is smaller than the ionization tendency of zinc, indium is generated from these indium ions before zinc is generated from zinc ions, and a base made of the generated indium is formed. Hence, it is not appropriate that the negative electrode liquid 22 would contain ions of gallium, germanium, or arsenic having ionization tendency greater than the ionization tendency of zinc.

### 1.12 First Control Example of Current Value and Flow Rate

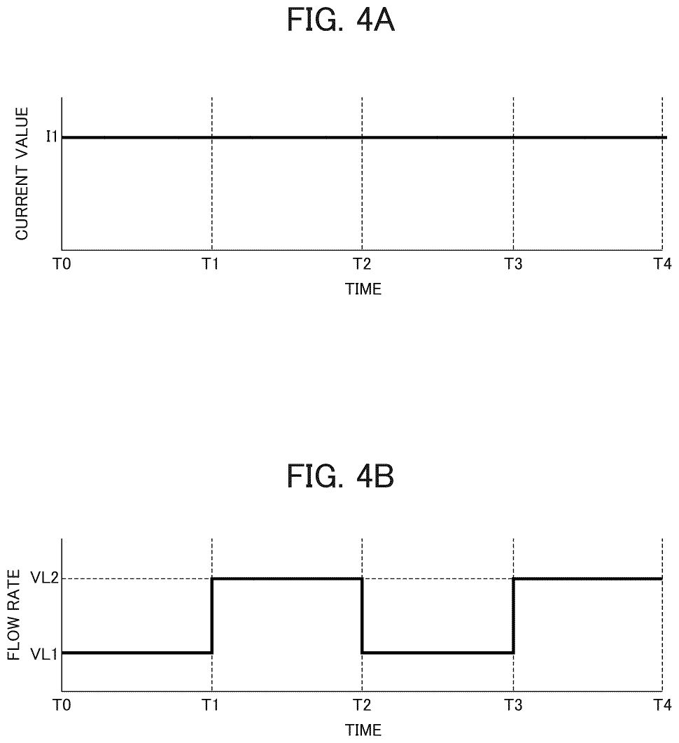

FIG. 4A is a graph showing a first control example of a current value of a current flowing between the positive electrode and the negative electrode of the rechargeable cell included in the metal-air flow battery of the first embodiment. FIG. 4B is a graph showing a first control example of a flow rate of a negative electrode liquid in the second flow path in the second layer of the rechargeable cell included in the metal-air flow battery of the first embodiment.

In FIG. 4A, the horizontal axis represents a time, and the vertical axis represents the current value. In FIG. 4B, the horizontal axis represents a time, and the vertical axis represents the flow rate.

In the first control examples of the current value of the current flowing between the positive electrode 93 and the negative electrode 98 and the flow rate of the negative electrode liquid 97 in the second flow path 96e of the second layer 96, as illustrated in FIG. 4A, the control circuit 81 serving as the energization control unit maintains the current value at a constant current value I1. Hence, the energization control unit sets the current value to a constant current value I1 in a period T0 to T4.

Furthermore, as illustrated in FIG. 4B, the control circuit 81 serving as the control unit periodically varies the flow rate between a first flow rate VL1 and a second flow rate VL2 higher than the first flow rate VL1. Hence, the control unit sets the flow rate to: the first flow rate VL1 in a period T0 to T1; the second flow rate VL2 in a period T1 to T2; the first flow rate VL1 in a period T2 to T3; and the second flow rate VL2 in a period T3 to T4.

When the negative electrode liquid 97 acts on the reduced negative-electrode active material particles 41a, drag is exerted on the reduced negative-electrode active material particles 41a. The drag is greater as the particle size of the reduced negative-electrode active material particles 41a is larger and the flow rate of the negative electrode liquid 97 is higher. Hence, in order to remove the reduced negative-electrode active material particles 41a from the negative electrode 98, and to discharge the reduced negative-electrode active material particles 41a, which has been removed, from the rechargeable cell 78, the flow rate of the negative electrode liquid 97 is desirably increased as soon as the particle size of the reduced negative-electrode active material particles 41a becomes large so as to instantaneously apply large drag to the reduced negative-electrode active material particles 41a.

If the current value and the flow rate are set as respectively illustrated in FIG. 4A and FIG. 4B, the metal-air flow battery 1 is recharged. During the period T0 to T1 and the period T2 to T3 in which the flow rate is decreased to the first flow rate VL1, the drag exerted on the reduced negative-electrode active material particles 41a becomes smaller. Accordingly, the reduced negative-electrode active material particles 41a grow. Hence, the reduced negative-electrode active material particles 41a become larger in particle size.

Then, during the period T1 to T2 and the period T3 to T4 in which the flow rate is increased to the second flow rate VL2, an increase is observed of the drag exerted on the reduced negative-electrode active material particles 41a whose particle size becomes larger.

These features make it possible to encourage removal of the reduced negative-electrode active material particles 41a from the negative electrode 98, and discharge of the reduced negative-electrode active material particles 41a, which has been removed, from the rechargeable cell 78. Furthermore, during the period T0 to T1 and the period T2 to T3, the flow rate is set to the first flow rate VL1. Such a feature makes it possible to reduce the power to be consumed to let the negative electrode liquid 97 flow.

As can be seen, the current value and the flow rate are controlled to encourage removal of the reduced negative-electrode active material particles 41a from the negative electrode 98. In such a case, a moving unit is not required for separating the reduced negative electrode particles 41a from the negative electrode 98. Thanks to the feature, the metal-air flow battery 1 can remove the reduced negative-electrode active material particles 41a from the negative electrode 98 without consuming a large amount of power, and achieve high durability.

Here, FIG. 4A exemplifies a control method for maintaining the current value at the constant current value I1 in the period T0 to T4. Alternatively, another control method may be adopted for varying the current value under a condition that the current value exceeds a predetermined current value in the period T0 to T4. Furthermore, FIG. 4B exemplifies a control method for maintaining the flow rate at: VL1 in the period T0 to T1 and the period T2 to T3; and VL2 in the period T1 to T2 and the period T3 to T4. Alternatively, another control method may be adopted for setting the flow rate to: VL1 or higher in the period T0 to T1 and the period T2 to T3, and VL2 or lower in the period T1 to T2 and the period T3 to T4.

Moreover, FIG. 4B exemplifies a control method for setting the period T0 to T1, the period T1 to T2, the period T2 to T3, and the period T3 to T4 to the same duration. Alternatively, in view of reducing consumption of power to let the negative electrode liquid 97 to flow, the period T1 to T2 and the period T3 to T4 are set shorter than the period T0 to T1 and the period T2 to T3. More desirably, the period T1 to T2 and the period T3 to T4 are set to one fifth to one twentieth as short as the period T0 to T1 and the period T2 to T3.

### 1.13 Second Control Example of Current Value and Flow Rate

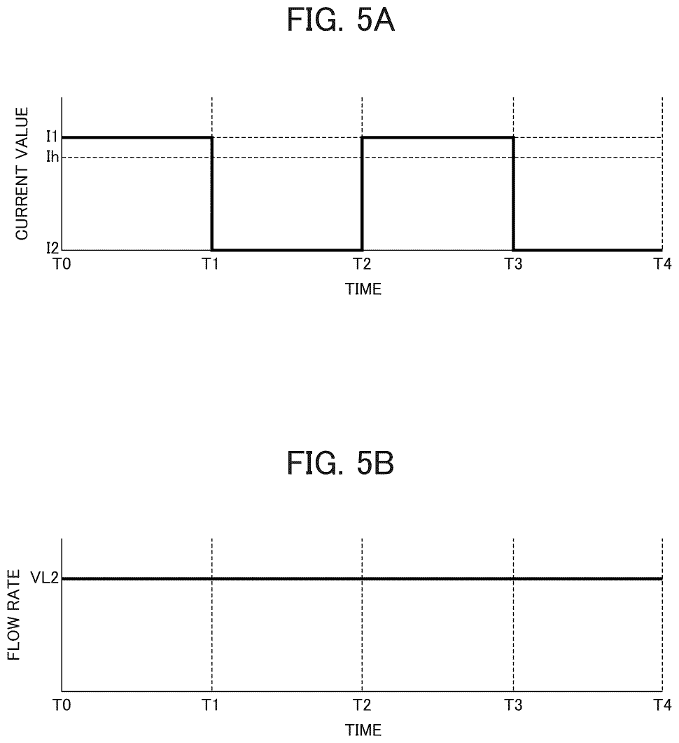

FIG. 5A is a graph showing a second control example of a current value of a current flowing between the positive electrode and the negative electrode of the rechargeable cell included in the metal-air flow battery of the first embodiment. FIG. 5B is a graph showing a second control example of a flow rate of a negative electrode liquid in the second flow path of the rechargeable cell included in the metal-air flow battery of the first embodiment.

In FIG. 5A, the horizontal axis represents a time, and the vertical axis represents the current value. In FIG. 5B, the horizontal axis represents a time, and the vertical axis represents the flow rate.

In the second control examples of the current value of the current flowing between the positive electrode 93 and the negative electrode 98 and the flow rate of the negative electrode liquid 97 in the second flow path 96e of the second layer 96, as illustrated in FIG. 5A, the control circuit 81 serving as the energization control unit periodically varies the current value between a first current value I1 and a second current value I2 smaller than the first current value I1. Hence, the energization control unit sets the current value to: the first current value I1 in the period T0 to T1; the second current value I2 in the period T1 to T2; the first current value I1 in the period T2 to T3; and the second current value I2 in the period T3 to T4. Desirably, the energization control unit sets the second current value I2 smaller than the first current value I1. More desirably, the energization control unit sets the second current value I2 to 0, and alternately performs the supply of the current between the positive electrode 93 and the negative electrode 98 and the reduction or suspension of the current between the positive electrode 93 and the negative electrode 98.

Furthermore, as illustrated in FIG. 5B, the control circuit 81 serving as the control unit maintains the flow rate at a constant flow rate VL2. Hence, the control unit sets the flow rate to the constant flow rate VL2 in the period T0 to T4.

When the negative electrode liquid 97 acts on the reduced negative-electrode active material particles 41a, drag is exerted on the reduced negative-electrode active material particles 41a. The drag is greater as the particle size of the reduced negative-electrode active material particles 41a is larger. Hence, in order to remove the reduced negative-electrode active material particles 41a from the negative electrode 98, and to discharge the reduced negative-electrode active material particles 41a, which has been removed, from the rechargeable cell 78, the reduced negative-electrode active material particles 41a are desirably larger in particle size. Note that while the reduced negative-electrode active material particles 41a are being removed from the negative electrode 98, the reduced negative-electrode active material particles 41a desirably stop growing.

If the current value and the flow rate are set as respectively illustrated in FIG. 5A and FIG. 5B, the reduced negative-electrode active material particles 41a grow in the period T0 to T1 and the period T2 to T3 in which the metal-air flow battery 1 is recharged at the first current value I1. Hence, the reduced negative-electrode active material particles 41a become larger in particle size.

Then, during the period T1 to T2 and the period T3 to T4 in which the metal-air flow battery 1 is recharged at the second current value I2, a great drag is exerted on the reduced negative-electrode active material particles 41a whose particle size becomes larger. The great drag removes the reduced negative-electrode active material particles 41a from the negative electrode 98. During the period T1 to T2 and the period T3 to T4, the growth of the reduced negative-electrode active material particles 41a is either reduced or stopped.

These features make it possible to encourage removal of the reduced negative-electrode active material particles 41a from the negative electrode 98, and discharge of the reduced negative-electrode active material particles 41a, which has been removed, from the rechargeable cell 78.

The first current value I1 may be set greater than a current value Ih at which a hydrogen-generating reaction starts to occur. The hydrogen-generating reaction is a competitive reaction of the reducing reaction that generates the reduced negative-electrode active material particles 41a with the negative electrode 98. Hence, the first current value I1 may be a current value greater than the current value Ih at which a hydrogen gas is generated on the negative electrode 98. The generated hydrogen gas raises an internal pressure of the second flow path 96e of the second layer 96, and increases the flow rate of the negative electrode liquid 97 in the second flow path 96e. Thus, if the hydrogen gas is generated on the negative electrode 98, the drag on the reduced negative-electrode active material particles 41a increases when the negative electrode liquid 97 acts on the reduced negative-electrode active material particles 41a. Such a feature can encourage removal of the reduced negative-electrode active material particles 41a from the negative electrode 98, and discharge of the reduced negative-electrode active material particles 41a, which has been removed, from the rechargeable cell 78. Furthermore, the generated hydrogen gas adheres to, and provide buoyancy to, the reduced negative-electrode active material particles 41a. Such a feature can encourage removal of the reduced negative-electrode active material particles 41a from the negative electrode 98, and discharge of the reduced negative-electrode active material particles 41a, which has been removed, from the rechargeable cell 78. Moreover, the generated hydrogen gas adheres to, and increases an apparent Stokes diameter of, the reduced negative-electrode active material particles 41a. Thus, if the hydrogen gas is generated on the negative electrode 98, the drag on the reduced negative-electrode active material particles 41a increases when the negative electrode liquid 97 acts on the reduced negative-electrode active material particles 41a. Such a feature can encourage removal of the reduced negative-electrode active material particles 41a from the negative electrode 98, and discharge of the reduced negative-electrode active material particles 41a, which has been removed, from the rechargeable cell 78.

As can be seen, the current value and the flow rate are controlled to encourage removal of the reduced negative-electrode active material particles 41a from the negative electrode 98. In such a case, a moving unit is not required for separating the reduced negative electrode particles 41a from the negative electrode 98. Thanks to the feature, the metal-air flow battery 1 can remove the reduced negative-electrode active material particles 41a from the negative electrode 98 without consuming a large amount of power, and achieve high durability.

Here, FIG. 5A exemplifies a control method for maintaining the current value at: I1 in the period T0 to T1 and the period T2 to T3; and I2 in the period T1 to T2 and the period T3 to T4. Alternatively, another control method may be adopted for setting the current value to: I1 or greater in the period T0 to T1 and the period T2 to T3, and I2 or smaller in the period T1 to T2 and the period T3 to T4. Furthermore, FIG. 5B exemplifies a control method for maintaining the flow rate at the constant flow rate VL2 in the period T0 to T4. Alternatively, another control method may be adopted for varying the flow rate under a condition that the flow rate exceeds a predetermined flow rate in the period T0 to T4.

Moreover, FIG. 5A exemplifies a control method for setting the period T0 to T1, the period T1 to T2, the period T2 to T3, and the period T3 to T4 to the same duration. Alternatively, in view of enhancing efficiency of the recharge reaction, the period T1 to T2 and the period T3 to T4 are set shorter than the period T0 to T1 and the period T2 to T3. More desirably, the period T1 to T2 and the period T3 to T4 are set to one fifth to one twentieth as short as the period T0 to T1 and the period T2 to T3.

### 1.14 Third Control Example of Current Value and Flow Rate

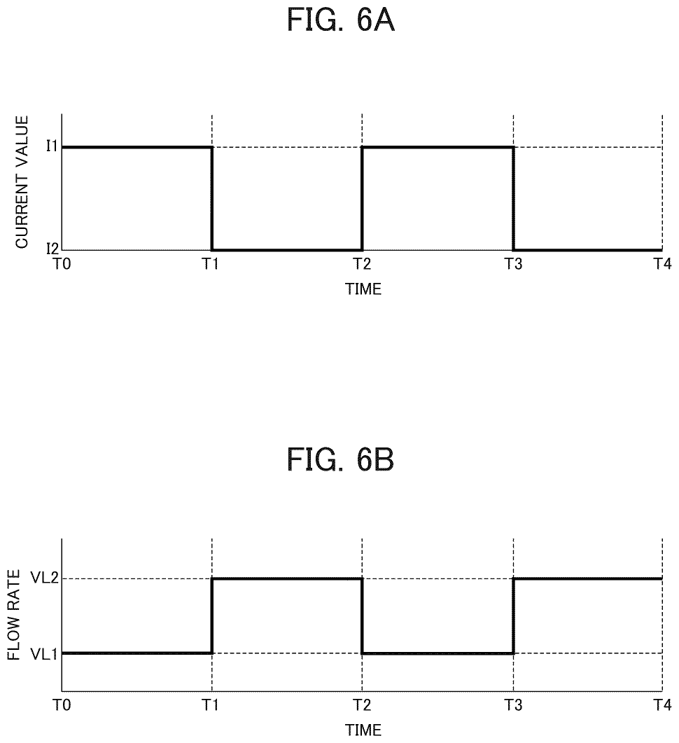

FIG. 6A is a graph showing a third control example of a current value of a current flowing between the positive electrode and the negative electrode of the rechargeable cell included in the metal-air flow battery of the first embodiment. FIG. 6B is a graph showing a third control example of a flow rate of a negative electrode liquid in the second flow path of the rechargeable cell included in the metal-air flow battery of the first embodiment.

In FIG. 6A, the horizontal axis represents a time, and the vertical axis represents the current value. In FIG. 6B, the horizontal axis represents a time, and the vertical axis represents the flow rate.

In the third control examples of the current value of the current flowing between the positive electrode 93 and the negative electrode 98 and the flow rate of the negative electrode liquid 97 in the second flow path 96e of the second layer 96, as illustrated in FIG. 6A, the control circuit 81 serving as the energization control unit periodically varies the current value between a first current value I1 and a second current value I2 smaller than the first current value I1. Hence, the energization control unit sets the current value to: the first current value I1 in the period T0 to T1; the second current value I2 in the period T1 to T2; the first current value I1 in the period T2 to T3; and the second current value I2 in the period T3 to T4. Desirably, the energization control unit sets the second current value I2 smaller than the first current value I1. More desirably, the energization control unit sets the second current value I2 to 0, and alternately supplies and reduces or suspends the current between the positive electrode 93 and the negative electrode 98.

Furthermore, as illustrated in FIG. 6B, the control circuit 81 serving as the control unit periodically varies the flow rate between a first flow rate VL1 and a second flow rate VL2 higher than the first flow rate VL1. Hence, the control unit sets the flow rate to: the first flow rate VL1 in a period T0 to T1; the second flow rate VL2 in a period T1 to T2; the first flow rate VL1 in a period T2 to T3; and the second flow rate VL2 in a period T3 to T4.

When the negative electrode liquid 98 acts on the reduced negative-electrode active material particles 41a, drag is exerted on the reduced negative-electrode active material particles 41a. The drag is greater as the particle size of the reduced negative-electrode active material particles 41a is larger and the flow rate of the negative electrode liquid 98 is higher. Hence, in order to remove the reduced negative-electrode active material particles 41a from the negative electrode 98, and to discharge the reduced negative-electrode active material particles 41a, which has been removed, from the rechargeable cell 78, the flow rate of the negative electrode liquid 98 is desirably increased as soon as the particle size of the reduced negative-electrode active material particles 41a becomes large so as to instantaneously apply large drag to the reduced negative-electrode active material particles 41a. Note that while the reduced negative-electrode active material particles 41a are being removed from the negative electrode 98, the reduced negative-electrode active material particles 41a desirably stop growing. Hence, the period T0 to T1 and the period T2 to T3 in which the metal-air flow battery 1 is recharged at the first current value I1 include the period T0 to T1 and the period T2 to T3 in which the flow rate is set to the first flow rate VL1. Furthermore, the period T1 to T2 and the period T3 to T4 in which the metal-air flow battery 1 is recharged at the second current value I2 include the period T1 to T2 and the period T3 to T4 in which the flow rate is set to the second flow rate VL2.

If the current value and the flow rate are set as respectively illustrated in FIG. 6A and FIG. 6B, the metal-air flow battery 1 is recharged at the first current value I1. During the period T0 to T1 and the period T2 to T3 in which the flow rate is decreased to the first flow rate VL1, the drag exerted on the reduced negative-electrode active material particles 41a becomes smaller. Accordingly, the reduced negative-electrode active material particles 41a grow. Hence, the reduced negative-electrode active material particles 41a become larger in particle size.

Then, during the period T1 to T2 and the period T3 to T4 in which the flow rate is increased to the second flow rate VL2, an increase is observed of the drag exerted on the reduced negative-electrode active material particles 41a whose particle size becomes larger. During the period T1 to T2 and the period T3 to T4, the growth of the reduced negative-electrode active material particles 41a is either reduced or stopped.

These features make it possible to encourage removal of the reduced negative-electrode active material particles 41a from the negative electrode 98, and discharge of the reduced negative-electrode active material particles 41a, which has been removed, from the rechargeable cell 78. Furthermore, during the period T1 to T2 and the period T2 to T3, the flow rate is set to the first flow rate VL1. Such a feature makes it possible to reduce the power to be consumed to let the negative electrode liquid 97 flow.

As can be seen, the current value and the flow rate are controlled to encourage removal of the reduced negative-electrode active material particles 41a from the negative electrode 98. In such a case, a moving unit is not required for separating the reduced negative electrode particles 41a from the negative electrode 98. Thanks to the feature, the metal-air flow battery 1 can remove the reduced negative-electrode active material particles 41a from the negative electrode 98 without consuming a large amount of power, and achieve high durability.

Here, FIG. 6A exemplifies a control method for maintaining the current value at: I1 in the period T0 to T1 and the period T2 to T3; and I2 in the period T1 to T2 and the period T3 to T4. Alternatively, another control method may be adopted for setting the current value to: I1 or greater in the period T0 to T1 and the period T2 to T3, and I2 or smaller in the period T1 to T2 and the period T3 to T4. Furthermore, FIG. 6B exemplifies a control method for maintaining the flow rate at: VL1 in the period T0 to T1 and the period T2 to T3; and VL2 in the period T1 to T2 and the period T3 to T4. Alternatively, another control method may be adopted for setting the flow rate to: VL1 or higher in the period T0 to T1 and the period T2 to T3, and VL2 or lower in the period T1 to T2 and the period T3 to T4.

Moreover, FIGS. 6A and 6B exemplify control methods for setting the period T0 to T1, the period T1 to T2, the period T2 to T3, and the period T3 to T4 to the same duration. Alternatively, in view of reducing consumption of power to let the negative electrode liquid 97 to flow and enhancing efficiency of the recharge reaction, the period T1 to T2 and the period T3 to T4 are set shorter than the period T0 to T1 and the period T2 to T3. More desirably, the period T1 to T2 and the period T3 to T4 are set to one fifth to one twentieth as short as the period T0 to T1 and the period T2 to T3.

### 1.15 Fourth Control Example of Current Value and Flow Rate

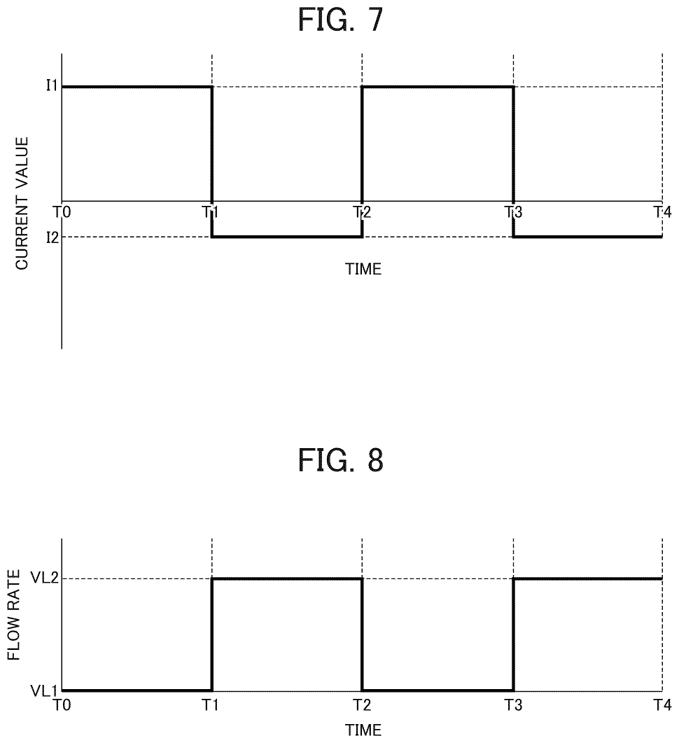

FIG. 7 is a graph showing a fourth control example of a current value of a current flowing between the positive electrode and the negative electrode of the rechargeable cell included in the metal-air flow battery of the first embodiment;

In FIG. 7, the horizontal axis represents a time, and the vertical axis represents the current value.

Described below will be a difference between: the fourth control example for controlling a current value of a current flowing between the positive electrode 93 and the negative electrode 98, and a flow rate of the negative electrode liquid 97 in the second flow path 96e of the second layer 96; and the third control example for controlling the current and the flow rate.

The fourth control example for controlling the current and the flow rate is conducted in the same manner as the third control example for controlling the current and the flow rate. As illustrated in FIG. 7, the control circuit 81 serving as the energization control unit periodically varies the current value between the first current value I1 and the second current value I2 smaller than the first current value I1.

However, the fourth control example for controlling the current and the flow rate is different from the third control example for controlling the current and the flow rate in that, as illustrated in FIG. 7, the first current value I1 and the second current value I2 are opposite in sign. Hence, the current flowing between the positive electrode 93 and the negative electrode 98 in the period T0 to T1 and the period T2 to T3 and the current flowing between the positive electrode 93 and the negative electrode 98 flow in opposite directions. The sign of the first current value I1 is positive, and the sign of the second current value I2 is negative. Hence, in the period T0 to T1 and the period T2 to T3, the negative electrode 98 causes the reduction reaction to metallic zinc. In the period T1 to T2 and the period T3 to T4, the negative electrode 98 causes the oxidation reaction to zinc ions. The oxidation reaction to zinc ions occurs at an interface between the negative electrode 98 and the reduced negative-electrode active material particles 41a. Hence, the oxidation reaction to zinc ions causes the reduced negative-electrode active material particles 41a to dissolve at the interface. Thus, the reduced negative-electrode active material particles 41a can be less likely to adhere to the negative electrode 98. Such a feature can encourage removal of the reduced negative-electrode active material particles 41a from the negative electrode 98, and discharge of the reduced negative-electrode active material particles 41a, which has been removed, from the rechargeable cell 78.

As can be seen, the current value and the flow rate are controlled to encourage removal of the reduced negative-electrode active material particles 41a from the negative electrode 98. In such a case, a moving unit is not required for separating the reduced negative electrode particles 41a from the negative electrode 98. Thanks to the feature, the metal-air flow battery 1 can remove the reduced negative-electrode active material particles 41a from the negative electrode 98 without consuming a large amount of power, and achieve high durability.

### 1.16 Fifth Control Example of Current Value and Flow Rate

FIG. 8 is a graph showing a fifth control example of a flow rate of a negative electrode liquid in the second flow path of the rechargeable cell included in the metal-air flow battery of the first embodiment.

In FIG. 8, the horizontal axis represents a time, and the vertical axis represents the flow rate.

Described below will be a difference between: the fifth control example for controlling a current value of a current flowing between the positive electrode 93 and the negative electrode 98, and a flow rate of the negative electrode liquid 97 in the second flow path 96e of the second layer 96; and the third control example for controlling the current and the flow rate.

The fifth control example is conducted in the same manner as the third control example for controlling the current and the flow rate. As illustrated in FIG. 8, the control circuit 81 serving as the energization control unit periodically varies the flow rate between the first flow rate LV1 and the second flow rate LV2 higher than the first flow rate LV1.

However, the fifth control example is different from the third control example for controlling the current and the flow rate in that, as illustrated in FIG. 8, the first flow rate VL1 is 0. Such a feature makes it possible to eliminate the need for the power to be consumed to let the negative electrode liquid 97 flow in the period T0 to T1 and the period T2 to T3. Furthermore, the fifth control example can limit the supply of the negative-electrode active material ions 42 to the negative electrode 98 in the period T0 to T1 and the period T2 to T3. Hence, the reduced negative-electrode active material particles 41a are encouraged to grow into bulky dendritic particles on the negative electrode 98. Such a feature can increase the drag on the reduced negative-electrode active material particles 41a when the negative electrode liquid 97 acts on the reduced negative-electrode active material particles 41a.

As can be seen, the current value and the flow rate are controlled to encourage removal of the reduced negative-electrode active material particles 41a from the negative electrode 98. In such a case, a moving unit is not required for separating the reduced negative electrode particles 41a from the negative electrode 98. Thanks to such a feature, the metal-air flow battery 1 can remove the reduced negative-electrode active material particles 41a from the negative electrode 98 without consuming a large amount of power, and achieve high durability.

### 1.17 Modifications

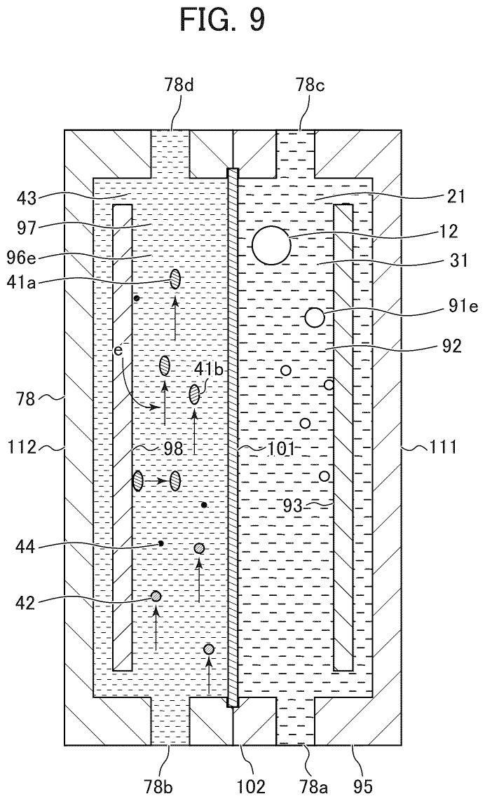

FIG. 9 is a cross-sectional view schematically illustrating the rechargeable cell included in the metal-air flow battery according to a first modification of the first embodiment.

In the first embodiment, as illustrated in FIG. 3, three positive-electrode-chamber-constituting members including the first layer 91, the conductive plate 94, and the gasket 95 constitute a positive-electrode chamber. Three negative-electrode-chamber-constituting members including the second layer 96, the conductive plate 99, and the gasket 100 constitute a negative-electrode chamber.

Whereas, in the first modification of the first embodiment, as illustrated in FIG. 9, one positive-electrode-chamber-constituting member 111 integrally including the first layer 91, the conductive plate 94, and the gasket 95 constitutes a positive-electrode chamber. One negative-electrode-chamber-constituting member 112 including the second layer 96, the conductive plate 99, and the gasket 100 constitutes a negative-electrode chamber.

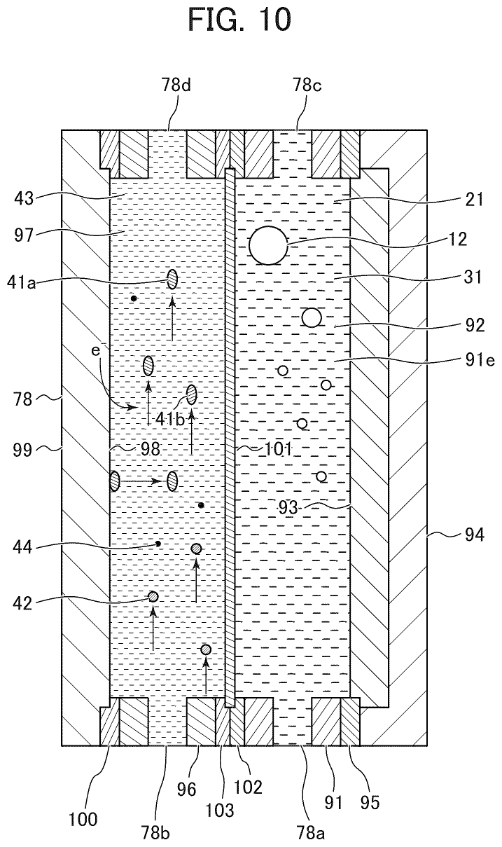

FIG. 10 is a cross-sectional view schematically illustrating the rechargeable cell included in the metal-air flow battery according to a second modification of the first embodiment.

In the first embodiment, as illustrated in FIG. 3, the negative electrode 98 and the conductive plate 99 are individually provided.

Whereas, in the second modification of the first embodiment, as illustrated in FIG. 10, the conductive plate 99 is formed integrally with, and also serves as, the negative electrode 98. That is, the negative electrode 98 and the conductive plate 99 are formed into one piece. Such a feature makes it possible to reduce the number of parts included in the rechargeable cell 78. Furthermore, the feature makes it possible to reduce the number of steps required for assembling the rechargeable cell 78. Moreover, the feature makes it possible to reduce a lead time required for assembling the rechargeable cell 78. As a result, the rechargeable cell 78 can be produced at low cost.

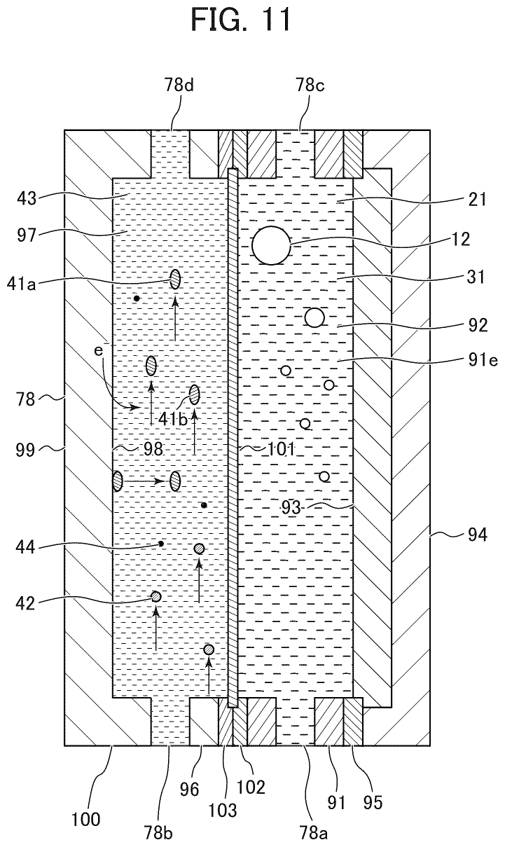

FIG. 11 is a cross-sectional view schematically illustrating the rechargeable cell included in the metal-air flow battery according to a third modification of the first embodiment.

In the first embodiment, as illustrated in FIG. 3, the second layer 96, the negative electrode 98, and the conductive plate 99 are individually provided.

Whereas, in the third modification of the first embodiment, as illustrated in FIG. 11, the conductive plate 99 is formed integrally with, and also serves as, the second layer 96 and the negative electrode 98. That is, the second layer 96, the negative electrode 98, and the conductive plate 99 are formed into one piece. Such a feature makes it possible to reduce the number of parts included in the rechargeable cell 78. Furthermore, the feature makes it possible to reduce the number of steps required for assembling the rechargeable cell 78. Moreover, the feature makes it possible to reduce a lead time required for assembling the rechargeable cell 78. As a result, the rechargeable cell 78 can be produced at low cost. Furthermore, the feature eliminates the need for the gasket 100 that liquid-tightly seals a gap between: the second layer 96; and the negative electrode 98 and the conductive plate 99. Such a feature can keep the negative electrode liquid 97 from leaking out of the negative-electrode chamber. Hence, the feature can enhance long-term stability and reliability of the rechargeable cell 78.

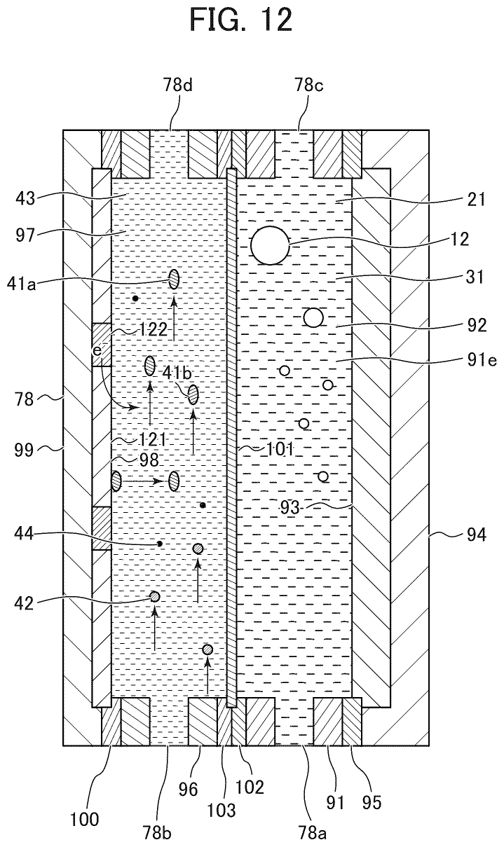

FIG. 12 is a cross-sectional view schematically illustrating the rechargeable cell included in the metal-air flow battery according to a fourth modification of the first embodiment.

In the fourth modification of the first embodiment, as illustrated in FIG. 12, the negative electrode 98 includes: a first portion 121 made of a first material; and a second portion 122 made of a second material. A hydrogen overvoltage of the second material is lower than a hydrogen overvoltage of the first material. Thanks to such a feature, a hydrogen gas is readily generated on the second portion 122. The generated hydrogen gas encourages, as described above, removal of the reduced negative-electrode active material particles 41a from the negative electrode 98, and discharge of the reduced negative-electrode active material particles 41a, which has been removed, from the rechargeable cell 78. The first material includes at least one selected from the group consisting of, for example, carbon, copper, and magnesium. The second material includes, for example, nickel.

### 1.18 Recharging Experiments

### First Recharging Experiment

As a first example, the rechargeable cell 78 illustrated in FIG. 3 was produced, and a recharging experiment was conducted, using the produced rechargeable cell 78.

The negative electrode 98 was made of carbon. Furthermore, the negative electrode 98 had a portion to be immersed into the negative electrode liquid 97, and the portion had a size of 10 mm×80 mm.

The positive electrode 93 was made of a nickel porous material. (i.e., Celmet (registered trademark) manufactured by Sumitomo Electric Industries Co., Ltd.) The positive electrode 93 had a portion to be immersed into the positive electrode liquid 92, and the portion had a size of 10 mm×80 mm.

The structure other than the negative electrode 98 and the positive electrode 93 was determined as follows.

The separator 101: “sheet separator of 0.1 mm in thickness and 20 mm×110 mm in size” manufactured by Nippon Shokubai Co., Ltd.

The positive electrode liquid 92: Zn-saturated KOH aqueous solution “KOH 29.2% and zinc oxide 4%”.

The negative electrode liquid 97: Zn-saturated KOH aqueous solution “KOH 29.2%, zinc oxide 4%, and a thickener 10”.

Here, the negative electrode liquid had a viscosity of 100 mPa·s when measured with the VT-06 manufactured by Rion Co., Ltd.

The rechargeable cell of a first comparative example was the same in configuration as the rechargeable cell 78 of the first example except for the configuration of the negative electrode liquid 97. The negative electrode liquid 97 of the first comparative example was prepared as follows.

The negative electrode liquid 97: Zn-saturated KOH aqueous solution “KOH 29.2% and zinc oxide 4%”.

Here, an Ubbelohde viscosity meter showed that the negative electrode liquid measured 2 mPa·s in viscosity.

The positive electrode liquid 92 and the negative electrode liquid 97 were sent through the rechargeable cell 78 of the first example and the rechargeable cell of the comparative example, and the recharging experiment was carried out. In the recharging experiment, the rechargeable cells were charged with a constant current at a current density of 100 mA/cm² (per projected area of the negative electrode 98). For the measurement, a battery tester (i.e., SPEC20526-PFX2011S manufactured by Kikusui Electronics Co., Ltd.) was used. In the recharging experiment, the weights were measured of the reduced negative-electrode active material (metallic zinc) particles 41a removed from the negative electrode 98 and discharged from the rechargeable cell 78 of the first example and from the rechargeable cell of the comparative example. Then, zinc collection rates were calculated in relation to an amount of input electricity. The calculation results are shown in Table 1.

$$Zinc Collection Rate ( \% ) = Weight of Discharged Zinc ( g ) \times 0.82 ( Ah / g \text{:} Specific Capacitance of Zinc ) / Amount of Input Electricity ( Ah ) \times 10 \; 0 .$$

TABLE 1

| | First | Second | Third |
|---|---|---|---|
| | Example | Example | Example |
| Zinc Collection Rate at Current | 68 | 94 | 0 |
| Density of 100 mA/cm² | | | |

As shown in Table 1, if the negative electrode liquid 97 has a low viscosity (the first comparative example), the reduced negative-electrode active material (metallic zinc) particles 41a are not discharged from the rechargeable cell. This is because, when the negative electrode liquid 97 acts on the reduced negative-electrode active material (metallic zinc) particles 41a, the drag on the reduced negative-electrode active material (metallic zinc) particles 41a decreases.

Whereas, if the negative electrode liquid 97 has a high viscosity (the first example), the reduced negative-electrode active material (metallic zinc) particles 41a are readily discharged from the rechargeable cell 78. This is because, when the negative electrode liquid 97 acts on the reduced negative-electrode active material (metallic zinc) particles 41a, the drag on the reduced negative-electrode active material (metallic zinc) particles 41a increases.

### Second Recharging Experiment

As a second example, a recharging experiment was conducted, using a rechargeable cell 78 that was the same as the rechargeable cell 78 of the first example except for the configuration of the negative electrode liquid 97. The negative electrode liquid 97 of the second comparative example was prepared as follows.

The negative electrode liquid 97: Zn-saturated KOH aqueous solution “KOH 29.2%, zinc oxide 4%, a thickener 1%, and indium hydroxide 0.01%”.

Here, the negative electrode liquid had a viscosity of 100 mPa·s when measured with the VT-06 manufactured by Rion Co., Ltd.

As shown in Table 1, if the negative electrode liquid 97 has a high viscosity and contains an additional component (indium ions), an improvement in collection rate is observed of the reduced negative-electrode active material (metallic zinc) particles 41a to be discharged from the rechargeable cell 78. This is because of a decrease in adhesion of the reduced negative-electrode active material (metallic zinc) particles 41a to the negative electrode 98. Hence, if the negative electrode liquid 97 has a high viscosity and contains an additional component (indium ions), such a feature further makes it easy to remove the reduced negative-electrode active material (zinc) particles 41a from the negative electrode 98 and discharge the reduced negative-electrode active material (metallic zinc) particles 41a, which has been removed, from the rechargeable cell 78.

### Third Recharging Experiment

As a third example, a recharging experiment was conducted, using a rechargeable cell 78 that was the same as the rechargeable cell 78 of the second example. The positive electrode liquid 92 and the negative electrode liquid 97 were respectively the same as the positive electrode liquid 92 and the negative electrode liquid 97 of the second example. Specifically, the positive electrode liquid 92 and the negative electrode liquid 97 were prepared as follows.

The positive electrode liquid 92: Zn-saturated KOH aqueous solution “KOH 29.2% and zinc oxide 4%”.

The negative electrode liquid 97: Zn-saturated KOH aqueous solution “KOH 29.2%, zinc oxide 4%, a thickener 1%, and indium hydroxide 0.01%”.

Here, the negative electrode liquid had a viscosity of 100 mPa·s when measured with the VT-06 manufactured by Rion Co., Ltd.

In the third recharging experiment, the rechargeable cell 78 was charged with a constant current at different current densities (per projected area of the negative electrode 98). In the recharging experiment, the weights were measured of the reduced negative-electrode active material (metallic zinc) particles 41a removed from the negative electrode 98 and discharged from the rechargeable cell 78. Then, zinc collection rates were calculated in relation to an amount of input electricity. The calculation results are shown in Table 2.

TABLE 2

| | Third Example | | | | |
|---|---|---|---|---|---|
| Current Density | 30 | 50 | 75 | 100 | 150 |
| (mA/cm²) | | | | | |
| Zinc Collection | 0 | 58 | 90 | 94 | 59 |
| Rate (%) | | | | | |

As shown in Table 2, a range of a preferable current density (per projected area of the negative electrode 98) is found for successfully increasing the collection rate of the reduced negative-electrode active material (metallic zinc) particles 41a to be discharged from the rechargeable cell. If the current density (per projected area of the negative electrode 98) is low (e.g., 30 mA/cm² and 50 mA/cm²), it is difficult to remove the reduced negative-electrode active material (metallic zinc) particles 41a from the negative electrode 98. This is because closely-dense and reduced negative-electrode active material (metallic zinc) particles 41a readily grow on the negative electrode 98, and, when the negative electrode liquid 97 acts on the reduced negative-electrode active material (metallic zinc) particles 41a, the drag on the reduced negative-electrode active material (metallic zinc) particles 41a decreases.

Whereas, if the current density (per projected area of the negative electrode 98) is high (e.g., 150 mA/cm²), it is easy to remove the reduced negative-electrode active material (metallic zinc) particles 41a from the negative electrode 98. However, a competitive reaction occurs of the reducing reaction that generates the reduced negative-electrode active material (metallic zinc) particles 41a; that is, a hydrogen-generating reaction, and zinc collection rate decreases.

### 1.19 Rechargeable Cell Stack

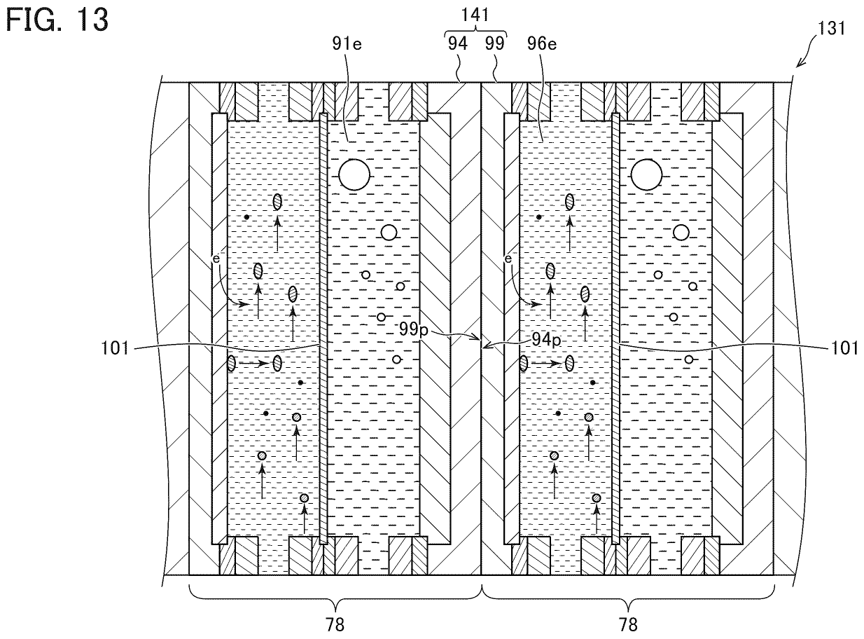

FIG. 13 is a cross-sectional view schematically illustrating a rechargeable cell stack that can be used instead of the rechargeable cell included in the metal-air flow battery of the first embodiment.

A rechargeable cell stack 131 illustrated in FIG. 13 includes a plurality of the rechargeable cells 78.

The plurality of rechargeable cells 78 are stacked together to constitute an assembled battery. Such a feature makes it possible recharge the rechargeable cell stack 131 with more power than one rechargeable cell 78.

The plurality of rechargeable cells 78 include two rechargeable cells 78 adjacent to each other. Of the two rechargeable cells 78 adjacent to each other, one rechargeable cell 78 has the conductive plate 94 provided with a main surface 94p. The main surface 94p is in facial contact with a main surface 99p of the conductive plate 99 of another rechargeable cell 78. Hence, the conductive plate 94 and the conductive plate 99 are electrically connected to each other to form a bipolar plate 141 having both functions of a positive electrode conductive plate and a negative electrode conductive plate. Thus, the plurality of rechargeable cells 78 are electrically connected in series.

Between the bipolar plate 141 and the separator 101 of one of the rechargeable cells 78, a positive electrode chamber is defined. Between the bipolar plate 141 and the separator 101 of another one of the rechargeable cells 78, a negative-electrode chamber is defined. The positive-electrode chamber defines the first flow path 91a. The negative-electrode chamber defines the second flow path 96e. The positive electrode liquid 92 flows in parallel into a plurality of the defined first flow paths 91e. The negative electrode liquid 97 flows in parallel into a plurality of the defined second flow paths 96e.

The present disclosure shall not be limited to the above-described embodiments, and may be replaced with a configuration substantially the same as, a configuration having the same advantageous effects as, or a configuration capable of achieving the same object as, the configurations described in the above-described embodiments.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A metal-air flow battery recharging unit, comprising:
a first layer defining a first flow path;
a positive electrode facing the first flow path;
a second layer defining a second flow path;
a negative electrode facing the second flow path;
a separator separating the first flow path and the second flow path from each other;
a positive electrode liquid flowing through the first flow path;
a negative electrode liquid flowing through the second flow path; and
a control unit configured to vary a flow rate of the negative electrode liquid in the second flow path.

2. The metal-air flow battery recharging unit according to claim 1,
wherein the control unit periodically varies the flow rate between a first flow rate and a second flow rate higher than the first flow rate.

3. The metal-air flow battery recharging unit according to claim 2,
wherein the control unit varies the flow rate so that a period during recharging includes a period in which the flow rate is the first flow rate.

4. The metal-air flow battery recharging unit according to claim 2,
wherein the control unit varies the flow rate so that a period during suspension of recharging includes a period in which the flow rate is the second flow rate.

5. A metal-air flow battery recharging unit, comprising:
a first layer defining a first flow path;
a positive electrode facing the first flow path;
a second layer defining a second flow path;
a negative electrode facing the second flow path;
a separator separating the first flow path and the second flow path from each other;
a positive electrode liquid flowing through the first flow path;
a negative electrode liquid flowing through the second flow path; and
an energization control unit configured to vary a current value of a current flowing between the positive electrode and the negative electrode.

6. The metal-air flow battery recharging unit according to claim 5,
wherein the energization control unit periodically varies the current value between a first current value and a second current value smaller than the first current value.

7. The metal-air flow battery recharging unit according to claim 6,
wherein the first current value and the second current value are opposite in sign.

8. The metal-air flow battery recharging unit according to claim 6,
wherein the first current value is a current value at which a hydrogen gas is generated on the negative electrode.

9. The metal-air flow battery recharging unit according to claim 1,
wherein the negative electrode includes: a first portion made of a first material; and a second portion made of a second material a hydrogen overvoltage of which is lower than a hydrogen overvoltage of the first material.

10. The metal-air flow battery recharging unit according to claim 1,
wherein the positive electrode causes a reaction to generate an oxygen gas, and the negative electrode causes a reaction to generate negative-electrode active material particles.

11. The metal-air flow battery recharging unit according to claim 1,
wherein the positive electrode liquid contains a first electrolyte solution, and
the negative electrode liquid contains: a second electrolyte solution; and a negative-electrode active material ions dissolved into the second electrolyte solution.

12. The metal-air flow battery recharging unit according to claim 11,
wherein the negative electrode liquid contains a thickener.

13. The metal-air flow battery recharging unit according to claim 1,
wherein the negative electrode liquid contains: zinc ions; and at least one kind of ions selected from the group consisting of Group 13 metal elements, Group 14 metal elements, and Group 15 metal elements.

14. The metal-air flow battery recharging unit according to claim 1,
wherein the negative electrode liquid contains: zinc ions; and indium ions.

15. The metal-air flow battery recharging unit according to claim 1,
wherein the separator is an anion exchange film, a hydrogel film, or a film including a plurality of inorganic ion conductor particles and a resin impregnated in grain boundaries between the plurality of inorganic ion conductor particles.

16. The metal-air flow battery recharging unit according to claim 1,
wherein the positive electrode contains nickel, and
the negative electrode contains at least one selected from the group consisting of, carbon, copper, and magnesium.

17. The metal-air flow battery recharging unit according to claim 1, further comprising
a conductive plate integrally formed with the negative electrode.

18. The metal-air flow battery recharging unit according to claim 1, further comprising
a conductive plate integrally formed with the negative electrode and the second layer.

19. The metal-air flow battery recharging unit according to claim 1,
wherein the first flow path includes a portion to guide the positive electrode liquid in a vertical direction, and
the metal-air flow battery recharging unit comprises a mechanism configured to create a flow of the positive electrode liquid in the portion from a vertically lower position toward a vertically upper position.

20. The metal-air flow battery recharging unit according to claim 1,
wherein the second flow path includes a portion to guide the negative electrode liquid in a vertical direction, and
the metal-air flow battery recharging unit comprises a mechanism configured to create a flow of the negative electrode liquid in the portion from a vertically lower position toward a vertically upper position.
